(19) United States
(12) Patent Application Publication
(10) Pub. No.: US 2003/0071998 A1
(43) Pub. Date: Apr. 17, 2003

(54) Color measurement device

(76) Inventors: F. Jeffrey Krupka, Greenwood Village, CO (US); Gregg Wagner, Boulder, CO (US)

Correspondence Address: John R. Posthumus, Esq., LeBoeuf, Lamb, Greene & MacRae, L.L.P., Suite 2000, 633 Seventeenth Street, Denver, CO, 80202, US

(21) Appl. No.: 10/264,649

(22) Filed: Oct. 4, 2002

Related U.S. Application Data
(60) Provisional application No. 60/363,477, filed on Mar. 11, 2002.
(60) Provisional application No. 60/327,366, filed on Oct. 4, 2001.

(51) Int. Cl. G01J 3/50

(52) U.S. Cl. 356/402; 356/406

(57) ABSTRACT

A portable color measuring device for determining a color of an object, is disclosed. The color measuring device is useful for measuring and analyzing an object's color in the visible light range. The devices also allow users with little training in color analysis to quickly and consistently perform accurate color measurements.

### RELATED APPLICATION

This application claims priority to U.S. Provisional Application Serial No. 60/363,477, filed on Mar. 11, 2002, and U.S. Provisional Application Serial No. 60/327,366, filed on Oct. 4, 2001, which are incorporated herein by reference.

### FIELD OF INVENTION

The present invention relates generally to the field of sensor technology and measurement. More specifically, the present invention relates to a portable device useful for measuring and analyzing an object's color frequencies in the visible light range.

### BACKGROUND OF INVENTION

One of the most profound aspects of modern science is the understanding and measurement of what we call light. Light waves occur in a full and complete range of frequencies. A frequency is defined as a number of waves that pass a particular point in space during a specific period of time. In other words, it is a measure of how often a periodic event occurs in relation to a time event. Frequency is usually measured in hertz (Hz), with 1 Hz equaling 1 occurrence or cycle per unit of time, usually a second.

Light waves interestingly also comprise both a magnetic and an electric field component. This dual nature of light waves often characterizes references to light as falling or occurring within a range of frequencies specific to the electromagnetic radiation spectrum. The size of a wave is determined by its wavelength. A wavelength is the distance or length in a periodic wave between two points of corresponding phase (usually peak to peak or trough to trough) in consecutive cycles. The wavelength is usually expressed in units of meters.

The full range of the electromagnetic spectrum through which light and other waves generally travel extends, on an arbitrary left hand side, from 200-400 nanometers (ultraviolet or gamma rays), to a middle region of 400-750 nm (visible light), to an arbitrary right hand side, to 750-1,100 nm (near infrared). The middle region—visible light—provides the most visible information to the naked human eye. One nanometer (nm) is equal to one billionth of a meter.

In many fields of endeavor, there is a need to measure light waves within the visible light range. For example, there is a growing need to quickly and objectively measure the color of a material or an object (inanimate or otherwise). There is also a need to compare the colors of different materials or objects with each other or against a reference standard, such as in matching paint colors in automobile repair shops or in quality control of manufacturing operations.

Existing methods and techniques generally fall into two categories: those that are simple and subjective; and those that are objective, but also complex and expensive. For example, in the first category are the typical color charts or swatches found in paint and furniture stores, and the like. Although simple and inexpensive, these methods are very subjective, oftentimes depending on the visual acuity, judgment and recollection of the user. In turn, the user's subjective color evaluation of a material depends on environmental variables, such as lighting. In addition, as a practical matter, the number of colors from which to choose is usually limited.

In the second category, existing devices that perform color evaluations objectively are complex and expensive. For example, many are large laboratory instruments that have separate bulky or bench-mounted components. Other smaller, self-contained devices contain expensive high-precision optical components and complex electronic circuitry that requires operation by an operator skilled in color analysis.

Thus, there is a need for a portable, preferably handheld, inexpensive measurement device that allows an operator unskilled in color analysis to quickly and objectively perform accurate color measurements consistently.

### SUMMARY OF INVENTION

The present invention satisfies, to a great extent, the foregoing and other needs not currently satisfied by existing technologies. It provides substantially portable flexibility in the gathering and recording of accurate measurements of frequency emissions of objects.

Yet another feature and advantage of the present invention is that it is compact, inexpensive and versatile. Versatility is enhanced by the use of designs that avoid specular reflection from glossy or irregular surfaces.

A further feature and advantage of the present invention is its easy-to-use display and/or other interfaces so that users with little training in color analysis may take accurate color measurements.

Another feature and advantage of the present invention is the configurability of its user interface(s) to display information in a variety of numerical formats for user use, as desired.

Another feature and advantage of the present invention is its ability to provide accurate color measurement in the visible light range with a hand-held device that is attachable, directly or indirectly, to one or more electronic devices.

Another feature and advantage of the present invention is its configurability for communication with one or more electronic databases.

Another feature and advantage of the present invention is the ease of calibration to sense frequencies in very specific as well as broad bands of the visible portion of the electromagnetic spectrum.

Yet another feature and advantage of the present invention is its flexibility and ease of compatibility, as the device may be operated in (physical or wireless) connection with a computing device, or operate as a standalone device, independent of attachment to one or more computing devices.

The above features and advantages are achieved by the present invention using basic procedures for measuring and analyzing electromagnetic frequencies of the visible light of an object, such as the object's color. In a preferred embodiment, the present invention comprises a hand-held, elongated probe.

In one embodiment, the color measurement device is contained within the probe and an integral display panel. Alternatively and optionally, the device may be contained within the probe only, being operatively connected to a separate display module by an electrical cable.

Preferably, the color measurement device of the present invention provides the capability of measuring a color of an exterior or interior surface color of an object. By way of operation, a measurement is made while placing the tip of the probe against, or in close proximity to, the surface of the object to be measured. Although measurement is made at the surface of an object, the color being measured may be inside the surface, as in the case or pigment or pigmentation within a transparent or translucent material.

The device generates, from a single measurement reading of a target, three color data points representing the reflectance of the target area measured at the wavelengths of three primary colors, such as red, green and blue. From those data points, a microprocessor within the device performs analyses yielding a single color value represented in a single measurement value. The single measurement reading is then presented on a display.

As used herein, the term “color value” refers to any representation of a measured color. For example, the representation may be a single number or a symbol. Alternatively, it may be a group of numbers or symbols, such as three RGB ratios, or a set of tri-stimulus values. A color value may also be represented by the result of a comparison of measured color values to other color values, which may be stored.

Light refers to all electromagnetic waves including infrared (IR), visible or ultraviolet light, which are controllable by optics. The color measurement device of the present invention is configurable to read specific or ranges of frequencies of spectral emissions for measurement, as desired, depending on the target. Preferably, the spectral response frequency of the device ranges from 400 to 750 nanometers, which corresponds to approximately 0.40 to 0.70 microns, or the visible light range.

The color measurement device of the present invention comprises a probe tip containing multiple light-emitting diodes (LEDs) for successively emitting light of different colors toward a target. It also comprises a light sensor, which receives light reflected from the target, and a light pipe for directing light from the LEDs to the target. The above-mentioned components are housed within the probe itself.

The LEDs surround the light sensor preferably in a circular arrangement within the probe tip. Light is conducted from the LEDs to the target via the solid portion of a hollow light pipe. The LEDs preferably emit three primary colors, which are preferably red, green and blue (RGB) and are preferably discrete in the sense that their wavelengths do not overlap. One or more LEDs of each color may be used depending on the efficiency of the LEDs of different colors and the level of illumination required.

The LEDs are embedded in, or abutted to, the proximal end of a hollow, semi-conical light pipe extending substantially from a substrate supporting the LEDs to the distal end of the probe tip. An opaque axial bore extends through the light pipe from near the probe tip to the light sensor. The bore provides a path for reflected light to reach the sensor and shields the sensor from direct light from the LEDs.

The light sensor is a relatively broad-spectrum device, which is sensitive to the wavelengths emitted by the LEDs. In operation, the LEDs are illuminated sequentially by color and the light of each color reflected from the target is sensed by the light sensor and represented by an analog electrical signal. The analog signal obtained from each color is converted to a digital signal whose value is then stored for analysis with the other color values.

In a first embodiment, the color measurement device takes the form of an elongated probe, which body contains substantially all the electronic circuitry for interfacing with the optical devices and for digitizing, storing and analyzing the reflected light signals. The probe body includes a single color sensor, an integral display panel, preferably a liquid crystal display (LCD), and associated circuitry for displaying the results of measurements. The target area is illuminated by tri-color LEDs (i.e. red, green and blue) when using the single color sensor. Alternatively and optionally, the target may be illuminated by white light LEDs when using a tri-color sensor. The color measurement device also includes a portable power supply for providing power to the device, and an actuator, such as a button or switch, for initiating a measurement.

In a second embodiment, the color measurement device is formed as a modular device having a probe body. The probe body contains substantially all the electronic circuitry for interfacing with the optical devices and for digitizing the reflected signals. It also contains an actuator, such as a switch, for initiating one or more measurements. However, in this embodiment, the display panel and the electronic circuitry for analyzing the reflected light signals, are located in a separate display module in remote connection to the probe body. The display module, which preferably displays a single measurement reading value, includes a portable power supply. Alternatively and optionally, the display module may include one or more menu buttons or switches for controlling one or more functions of the color measurement device.

There has been outlined rather broadly, the important features of the invention in order that a detailed description thereof that follows may be better understood, and in order that the present contribution to the art may be better appreciated. There are additional features of the invention that will be described hereinafter and which will form the subject matter of the claims appended hereto.

In this regard, before explaining at least one embodiment of the invention in detail, it is to be understood that the present invention is not limited in its application to the details of construction (i.e. physical shape) and to the arrangements of the specific components set forth in the following description or illustrated in the drawings only. The present invention is capable of other embodiments and of being practiced and implemented in various ways. Also, it is to be understood that the phraseology and terminology employed herein are for the purpose of description and should not be regarded as limiting.

As such, those skilled in the art will appreciate that the conception, upon which this disclosure is based, may be readily used as a basis for designing and/or arrangement of other structures, methods and systems for carrying out the several purposes of the present invention. It is important, therefore, that the claims be regarded as including such equivalent constructions insofar as they do not depart from the spirit and scope of the present invention.

The above features and advantages of the present invention, together with other apparent features and advantages of the invention, along with the various features of novelty that characterize the invention, are pointed out with particularity therein. For a more detailed description of the present invention, its operating advantages and the specific features and objects attained by its uses, reference should be had to the accompanying drawings and descriptive matter, which illustrates preferred embodiments of the present invention.

### BRIEF DESCRIPTION OF PREFERRED EMBODIMENTS

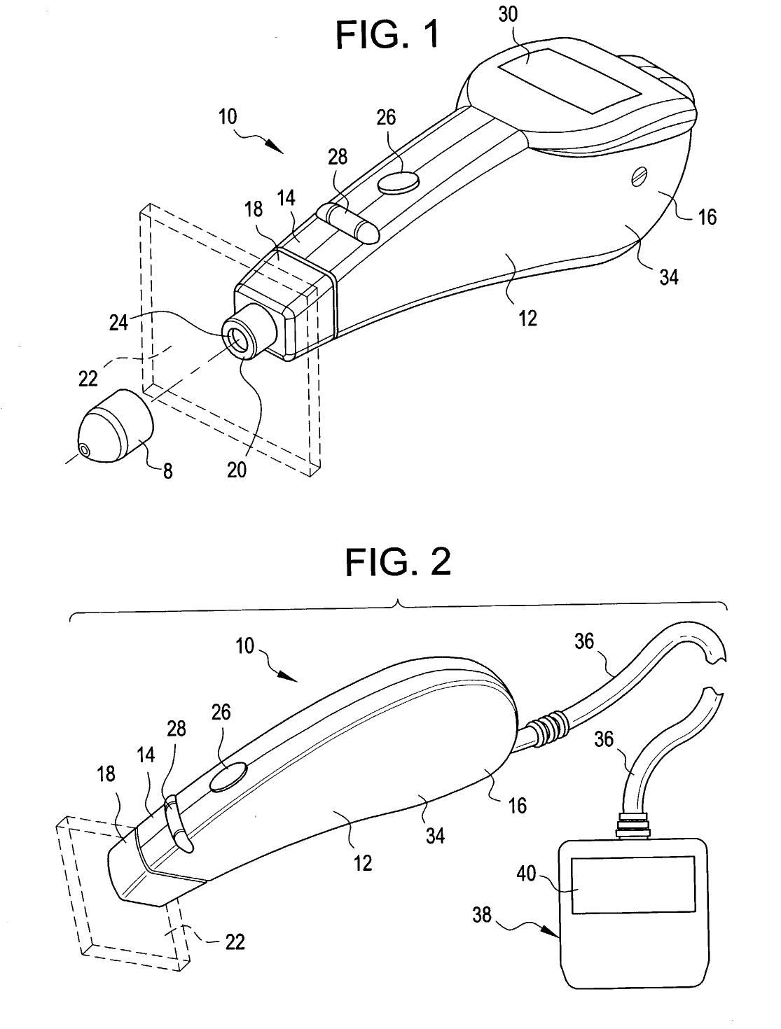

FIG. 1 is a perspective view of a color measurement device in accordance with a preferred embodiment of the present invention.

FIG. 2 is a perspective view of a modular form of the present invention.

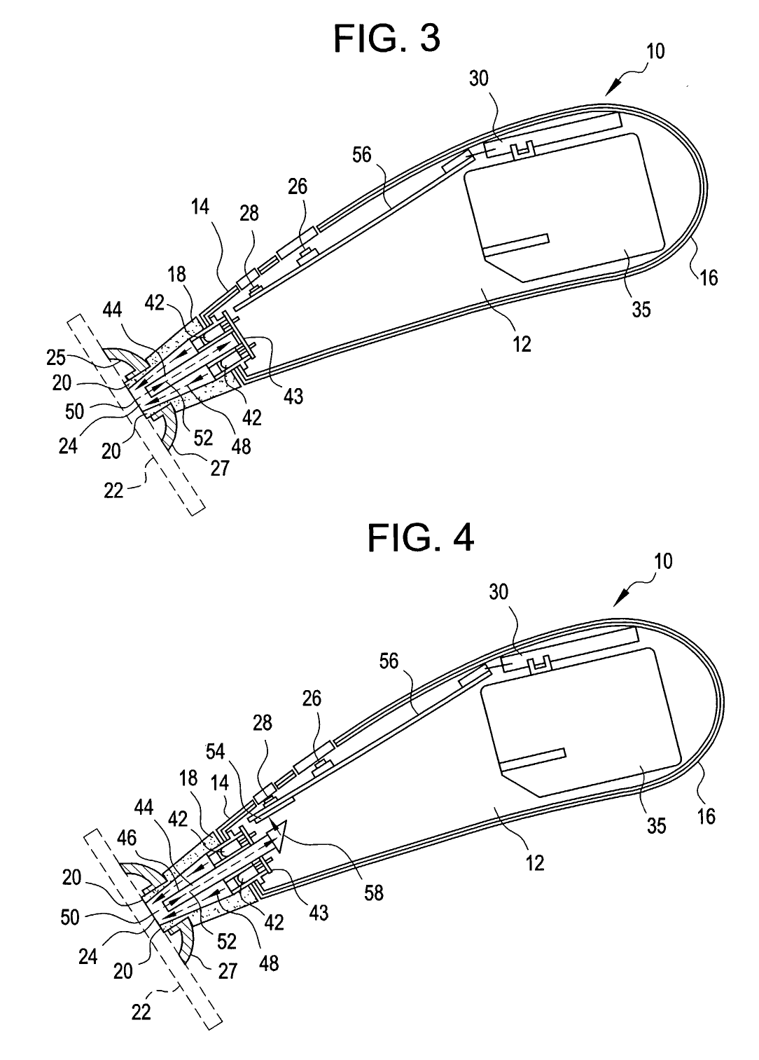

FIG. 3 is a side sectional view of the device of FIG. 1.

FIG. 4 is a side section view of the device of FIG. 1 showing a light pipe having a turning prism.

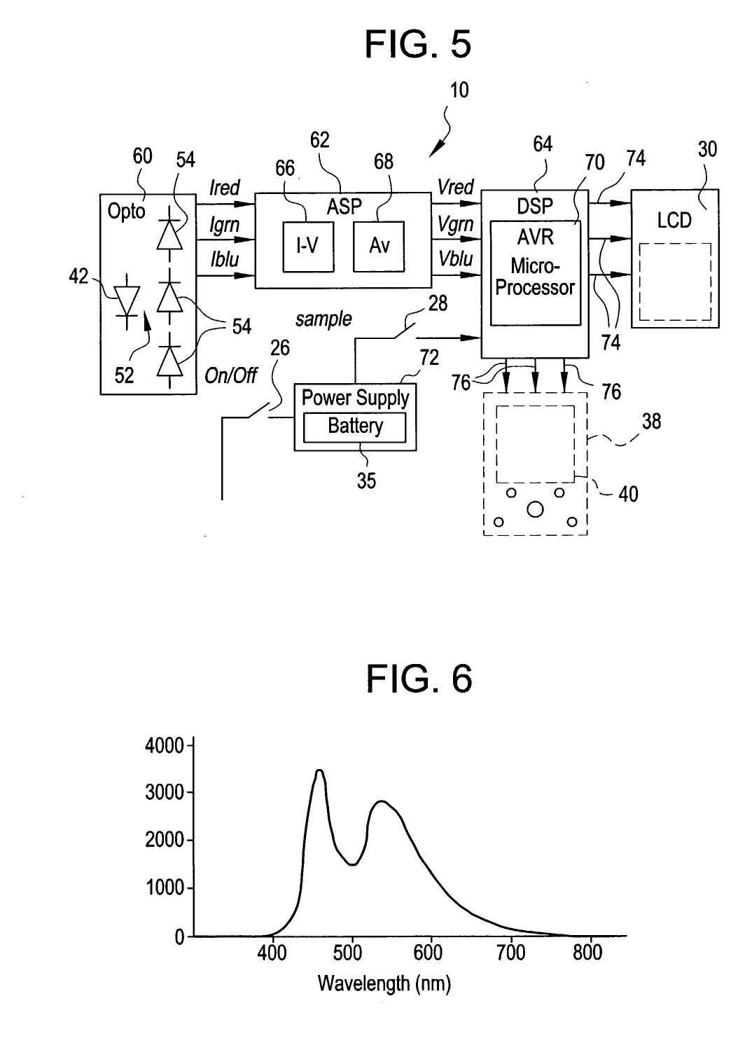

FIG. 5 is a circuit diagram of the electronics of the device of FIG. 1.

FIG. 6 is a spectral diagram of a white LED source of the present invention.

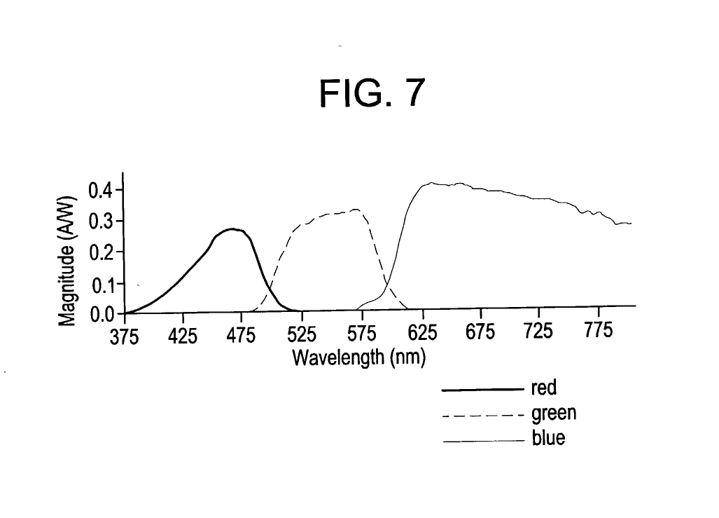

FIG. 7 is a plot of red-green-blue sensitivity of the present invention.

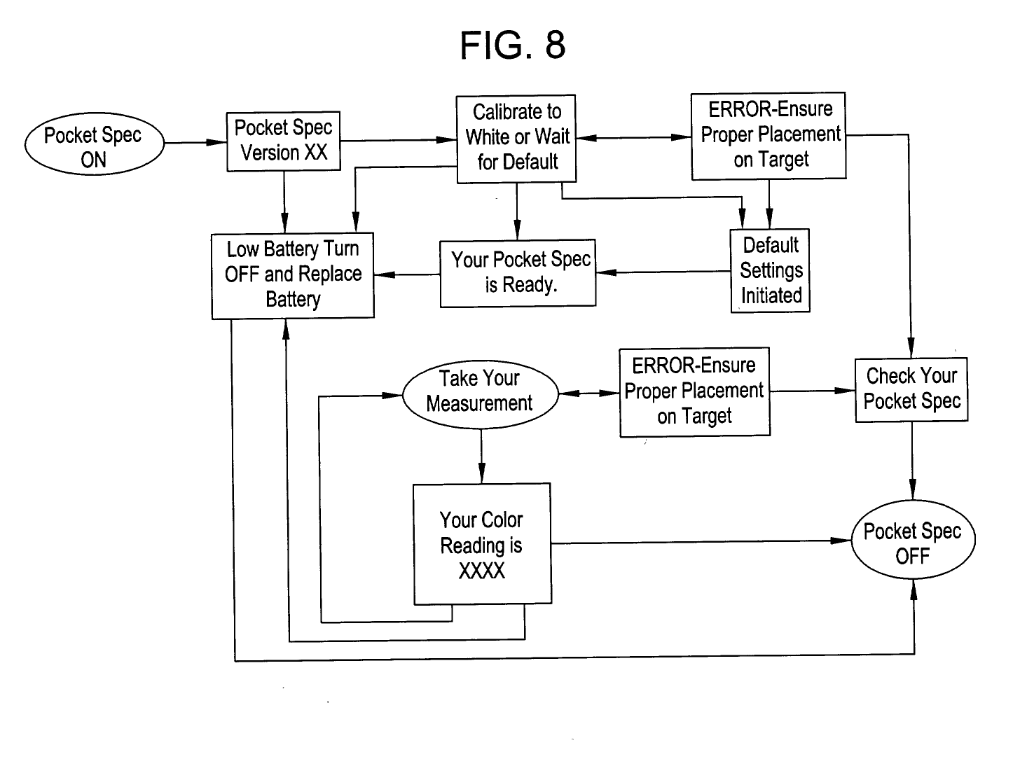

FIG. 8 is a state diagram of the color measurement device.

### DETAILED DESCRIPTION OF PREFERRED EMBODIMENTS

Referring now to the figures, like reference numerals indicate like features or elements. The drawings and the following detailed descriptions show illustrative embodiments of the invention. Numerous details including materials, dimensions, and products are provided to illustrate the invention and to provide a more thorough understanding the invention. However, it will be obvious to one skilled in the art that the present invention may be practiced without limitation to these specific details.

In a preferred embodiment, the present invention is directed to a lightweight, handheld, portable color measuring device used for analyzing and/or measuring colors. A color analysis performed by the device produces a single measurement value. The value is derived from reading the percentages of red, green and blue detected in a target and, through calculations, deriving a color scale, which ranges between zero and 1,000. Further, alternatively and optionally, the range may be as desired, such as from zero to 300 or zero to 10,000.

In one embodiment, the scale may be calibrated such that 1,000 represents the color black, and zero represents the color white. Alternatively and optionally, 1,000 may represent the color white and zero may represent the color black.

Preferably, the color measuring device is a stand-alone unit including its own built-in display. Alternatively and optionally, the device may be configured for connectivity to a variety of electronic devices such as a personal computer, pager device, cellular telephone, personal digital assistant, television, and the like.

Referring now to FIG. 1, there is shown an exterior view of a preferred embodiment of the present invention. The color measurement device 10 comprises a probe body 12, probe tip 18, display panel 30, a color measurement button 28 and an on/off switch 26. The probe body 12 has a first end portion 14 and a second end portion 16. The probe tip 18, which is preferably hollow, is attached to the first end portion 14 of the probe body 12.

A target contact end 20 of the probe tip 18 is shown being placed against a color target 22 for measuring and analyzing the target's color. The contact end 20 preferably includes an annular contact end opening 24 for receiving light therethrough.

The probe tip 18 may also be configured to include a light shield 25 (FIG. 3) having a flexible annular ring 27. The light shield 25 is useful for a color target 22 having a rough or non-smooth surface. By way of operation, when the light shield 25 engages a portion of a target 22, it prevents ambient light from entering into the target area, thereby facilitating an accurate color measurement reading. The target 22 may be any object or item (inanimate or otherwise), such as an injection molded product, paint sample, building, vehicle, tooth, skin area, cosmetic, etc., as desired.

The exterior of the device 10 includes an on/off switch 26 for turning the device 10 “on” and “off”, as well as a color measurement button 28 for illuminating the target 22 in the measurement process. The probe body 12 also includes, in the vicinity of the second end portion 16, a display 30, preferably a liquid crystal display (LCD) 30. The display 30 shows a single measurement value between the range of zero and 1,000.

In FIG. 2, a perspective view of another embodiment of the color measuring device 10 is illustrated. In this drawing, the probe housing 12 is shown without the built-in liquid crystal display 30 and without the light shield 25. The second end 16 of the probe housing is shown attached to a communications cable 36 for connecting the color measuring device 10 to an electronic device 38 having a visual display 40. The electronic device 38, for example, may be a Compact Companion, a Palm Pocket PC, a Handspring Pocket PC, handhelds/personal digital assistants, and the like for calculating a single color measurement.

In FIG. 3, a side, sectional view of the handheld portable color measuring device 10, as shown in FIG. 1, is illustrated. In this drawing the internal components inside the elongated probe housing 12 are shown.

Inside the first end portion 14 of the probe housing 12 is a light source 42, preferably a white LED, connected to the color measurement switch 28 and mounted on an illumination printed circuit board 43. Alternatively and optionally, an array of red, green and blue LED's can be used to accomplish the same color scale results. The light source 42 is made up of a plurality of white LED lamps spaced around a portion of an outer circumference of a light pipe 44. The light pipe 44 includes a dark light block 46 (FIG. 4) disposed around its outer circumference. The light block 46 prevents the light source 42 from filtering, into the inside of the light pipe 44 and interfering with the reflected light signal. When the measurement switch 26 is actuated, the white light source 24 illuminates, as indicated by arrows 48, a target area 50 on the color target 22. The target contact end 20 of the probe tip 18 surrounds the target area 50 of the color target. While the light pipe 44 is shown in the drawings, it is anticipated that other types of optical lens could be used and if desired for receiving the reflected light signal in the probe housing 12 and projecting the signal onto a color sensor.

The inside of the light pipe 44 captures reflected light, in the form of an analog light signal as indicated by dashed arrow 52, off the target area 50 and projects the captured light signal onto a 3 color (RGB) sensor 54 (FIG. 4) or tri-color photodiode. The sensor 54 is also mounted on the printed circuit board 56. The sensor 54 collects the analog light signal, which is made up of percentages of red, green and blue. The percentages of color may be detected simultaneously or sequentially. It should be mentioned that while the sensor 54 is discussed herein for measuring different percentages of the primary colors, red, green and blue, there are photodiode color sensors for measuring magenta, yellow, cyan and black. Therefore, while it is preferable to measure the primary colors of red, green and blue, three or more other colors can be measured if desired using the subject color measuring device 10.

The analog light signal 52 is amplified and converted from an analog to a digital light signal by an A/D converter. The A/D converter is incorporated into a printed circuit board 56. The printed circuit board 56 also includes a microprocessor and data storage memory. The digital light signal is transmitted from the microprocessor on to printed circuit board 56 to the liquid crystal display 30 or, as shown in FIG. 2, transmitted via the communication cable 36, preferably a RS 232 electrical lead, to an electronic device 38.

In FIG. 4, another side sectional view of the handheld portable color measuring device 10, as shown in FIG. 1, is illustrated. In this example, a 90-degree turning prism 58 is shown mounted on the end of the light pipe 44. The prism 90 is used to reflect the analog light signal 52 on to the 3-color sensor 54. The sensor 54 is mounted on the printed circuit board 56 and connected to the A/D converter. The turning prism 58 is shown to illustrate one of many ways the reflected analog light signal 52 can be transmitted to the 3 color sensor 54.

While not shown in the drawings, a calibration cap having a white coating thereon can be used for calibrating the device 10 to a white standard prior to measuring the color target 22. For example, the calibration cap would be dimensioned and shaped to slip around the target contact end 20 and a portion of the probe tip 18 in a press fit. The color measurement switch 28 would then be activated and the device 10 would be calibrated to the white standard using the microprocessor on the printed circuit board 56.

In FIG. 5, a circuit diagram of the optical and electrical components making up the color measuring device 10 is shown. The diagram includes an Opto module 60 made up of the white LED light source 42 and the 3 color sensor 54. The white light, transmitted by the LED lamps, is reflected off the target 22 (FIG. 4) and focused on the photodiodes of the sensor 54. The sensor converts the light energy to an electrical current proportional to the energy of the reflected light. The output from the Opto module 60 is illustrated as arrows identified as I red, I grn, and I blu.

An ASP (Analog Signal Processor) module 62 converts the electrical current mode signals from the 3-color sensors 54 to voltage mode signals suitable for a DSP (Digital Signal Processor) module 64, an I-V (current to voltage) conversion 66 can be implemented with a tram-impedance amplifier or a standard op-amp. If necessary, a voltage amplification Av 68 can follow the I-V conversion 66. In addition, the ASP module 62 can provide a gain balance between the red, green and blue voltage channels. The output from the ASP module 62 is illustrated as arrows identified as V red, V grn, and V blu.

The DSP (Digital Signal Processor) module 64 includes an AVR (AdVanced RISC) microprocessor 70. The microprocessor 70 includes a multi-channel A/D converter which converts the three voltage outputs from the ASP module 62 to a 10 bit digital representation. Programmed algorithms executed by the AVR microprocessor 70 accomplish the analysis of the color data. The DSP module 64 also controls the operational modes of a connected computer 38, monitors the color measurement switch 28 used to initiate the color measurement or calibrate the color measuring device 10, and controls the operation of the light source 42, the 3 color sensor 54 and the LCD display 30. Also, the AVR microprocessor 70 can be used to perform system power management to preserve the life of the battery 35. The above mentioned ASP module 62 and the DSP module 64 are incorporated into the printed circuit board 56 shown in FIGS. 3 and 4.

A power supply block 72 contains the battery 35 for providing the necessary voltage regulation for the analog and digital components and provides the necessary voltage for the LED amps. Also, a separate low-dropout regulator is used for the Opto, ASP, DSP and the LCD components described above. The on/off switch 26 services two functions. It disconnects the load from the battery 35 to maximize battery life. Also, it provides the necessary variable state, which forces the AVR 70 into a calibration mode. When the switch 26 is cycled from an “off” to “on” position, the microprocessor's reset register will reflect this condition and will be programmed to enter into a calibration mode. At this time, the device 10 prompts the user to depress the measurement switch 28 to select a default calibration setting, or wait until prompted to calibrate a white standard. The white standard is contained with a white cap placed over the end of the probe tip 18. If the calibration is selected, the cap is held against the probe tip 18 and the measurement switch 28 is depressed. At this time, the calibration data in the microprocessor 70 is used to compare all future measurements of the target 22 (FIG. 4) until the switch 26 is turned “off”. The device 10 is then calibrated each time the unit is turned “on”.

Also shown in FIG. 5 is the LCD display 30 connected to the microprocessor 70 as shown solid arrows 74. Further, if the device 10 does not have the built-in display 30, the microprocessor 70 is connected to a personal computer as shown by arrows 76.

In FIG. 6, an illustration of a white LED spectrum is shown. The diagram shows the intensity levels of the white LEDS over a range of 400 to 700 nanometers. This range is a typical color range detected by the human eye.

In FIG. 7, a typical spectral sensitivity of the 3-color sensor 54 (FIG. 4), used in the subject color measuring device 10, is shown measuring blue, green and red color spectrums in an optical wavelength (nm) and sensitiveness (A/W). In this example, the color red is measured over a wavelength range of from 450 to 520 nm, the color green is measured over a wavelength range of 500 to 620 nm and the color blue is measured over a wavelength range of 600 to 725 nm.

In FIG. 8, a diagram of the various states of operation of the color measuring device 10 is shown. For example, when the on/off switch 26 is turned “on” a PocketSpec version X.X” is displayed on the built-in display 30 (FIG. 1) or on the computer visual display 40 (FIG. 2). If the battery 35 is low, the display will state “Low Battery Turn Off and Replace Battery”. If the battery 35 is not low, the display will state “Calibrate to White or Wait for Default”.

If the decision to calibrate to the white standard is selected, the white cap 8 (FIG. 1) is placed next to or around the probe tip 18 and the measurement switch 28 is activated. The color measuring device 10 is now calibrated until it is turned off. If no color measurements are taken, the unit will revert to a default setting.

Once the calibration step has been completed, the device 10 is ready to measure colors. The last color measurement will remain displayed until the next color measurement is performed. For systems connected to a computer, as shown in FIG. 2, several measurements can be stored, but only the last measurement is displayed.

At any time during color measuring, the device is design to ensure that there is enough power in the battery 35, the display will indicate a “Low Battery” warning. Also the color measuring device 10 will warn the user if an error in measuring has occurred. For example, if the user takes a color measurement while the unit is pointed toward ambient lighting, the 3 color sensor 54 will saturate and an error message is displayed.

Alternatively and optionally, the display module 10 is operatively connectable with other electronic devices through infrared (IR) or radio frequency (RF) links, cables and other communications medium.

Although the present invention encompasses the use of monochromatic, discrete-color and white light sources, emitted colors are referred to as having nominal wavelengths, and (optionally) some distribution of light intensity at other wavelengths. Various intensity distributions may prove advantageous for a user, depending on component availability or human visual acuity. For example, a two-color light source system may be more advantageous for a particular use of the probe, based on the user's knowledge about the intended use. For instance, the color of a tooth is generally measured adequately by red and yellow light sources.

The present invention also has application in the dental field. The portable color measurement device of the present invention is usable to calculate a single color measurement value on any area of a patient's tooth that a dental care professional can use to match with existing and/or custom color tables. This can be done for composite fillings, false teeth, caps and the like. The removable and/or interchangeable cap 8 or precision tip 8 provides a sanitary and disposable feature that is highly valued in the health field, and any other areas for measuring color. For example, precision tip 8 may be a rubber tip used for measuring small areas, such as a tooth, mole or skin tissue/lesion.

The tip preferably includes a plastic, photo-quality cover that prevents moisture, dirt, debris, and bacteria from entering the tip. Additionally, the tip may include an over-molded insulation strip, provided between the two assembly halves and around the probe tip, to increase water resistance and create a barrier to prevent bacteria seepage into the device. This feature is important for cleaning the device between uses. The photo-quality of the cover also allows accurate color readings without impairment. In addition, a flexible O-ring may be included that both recesses the plastic cover from the tooth, so that moisture and saliva is less likely to impair an accurate reading, and the flexible tip accommodates irregular tooth surface.

The device of the present invention also has application in cosmetics, such as in determining a skin tone color of face powders or foundations. The device is configurable to accurately calculate a person's natural skin color by reducing the light emission to a level that gets the skin color, but not the blood under the surface of the skin. The process of calculating natural skin color may incorporate subjective data of a make-up technician or user.

The application of the device is not limited to cosmetics, but may broadly include accessories, such as calculating a color value for nail color, clothing, shoes, purses, and the like. The idea here is use of the device in accurately determining the color of a hand bag, for example, and then accurately determining the color of nail colors for purposes of selecting the appropriate color.

There is no restriction on the number of colors or skin color types usable with the device. The technology of the present invention solves the unavailability of needed colors by creating a stream of data gathered from customers who submit to color testing, or items that are color tested. Data may be gathered and manipulated to create new foundation colors, skin types, etc.

In yet another instance, the device has application to the field of dermatology, where the device may take the form of a dermatology probe used to determine a color or color change in skin lesions and/or moles. Along the same lines, the device is useful to determine the change of a tan.

It is important to note that the present invention is useful in monitoring, and/or in medical diagnoses for measuring and analyzing electromagnetic frequencies in the color spectrum for body fluids and tissues. It provides a system and method for providing accurate measurement and analysis of body tissue and/or fluid color that is inexpensive, practical and convenient.

For example, the hand held color sensor of the present invention is configurable to provide a single measurement or comparison measurement read-out of the color signature of tissue or fluid. The read out may take a numerical, tabular, chart or graphic form, as desired, and may then be cross-matched and/or correlated to a physician's database of related analyses, for instance.

In this regard, the device of the present invention is usable, for instance, to target various spectral frequencies and/or associated body fluids and/or tissues whose specific color can be matched to a disease characteristic.

Yet another feature and advantage of the present invention is its adaptability to varied medical applications. For instance, a preferred embodiment of the invention as a hand-held device allows doctors to measure color radiation emission of body tissue samples, such as blood or urine, on site rather than through third party testing. In other words, the hand held embodiment of the present invention, properly calibrated to detect a specific color frequency associated with a diseased tissue or fluid, could provide immediate on-site analysis, thus reducing diagnosis time and expediting administration of treatment.

Alternatively and optionally, the present invention is configurable to measure and analyze electromagnetic frequencies other than in the color spectrum. For example, the portable embodiment of the sensor of the present invention is configurable to accommodate one or more sensor modules equipped to detect chemical compounds/entities and/or electrical elements, useful in a wide range of diagnostic procedures.

For example, this includes diabetes detection and monitoring, analysis of electrocardiac pulses and variations, analysis of electroencephalogram (EEG) signals of extremely low voltage, and other electrical and/or chemical procedures. The portability of a small sized sensor, such as the instant invention, facilitates the availability of on-site testing at significantly reduced costs to consumers.

The description and drawings herein are to be construed as examples only of the present invention. The many features and advantages of the invention are apparent from the detailed specification.

Further, since many modifications and variations will readily occur to those skilled in the art, it is not desired to limit the present invention to the exact construction and operation illustrated and described. Accordingly, all suitable modifications and equivalents similarly fall within the scope of the present invention.

What is claimed is:

1. A color measuring device for determining a color of a target, said device comprising:
a probe housing having a switch mounted thereon;
a probe tip attached to one end of said probe housing;
a light source mounted inside the probe housing and connected to a power source;
a sensor mounted inside said probe housing;
a microprocessor mounted in said probe housing for processing a reflected light signal; and
a display, connected to said microprocessor, that displays a single measurement value.

2. The device as claimed in claim 1, wherein said display is integrally mounted in said probe housing.

3. The device as claimed in claim 1, wherein said display is an electronic device connected to said microprocessor.

4. The device as claimed in claim 1 wherein, said light source is a white LED light source.

5. The device as claimed in claim 1, wherein said power source is a battery.

6. The device as claimed in claim 1, further comprising a light pipe disposed inside said probe housing.

7. A portable color measuring device for determining a color of an object, said device comprising:
an elongated probe housing having a switch;
a probe tip attached to one end of the probe housing;
a light source mounted inside the probe housing connected to a battery power source;
a light pipe located inside said probe housing, said light pipe capturing a reflected light signal off the object;
a sensor connected to said battery power source and mounted inside said probe housing;
a microprocessor connected to said battery power source and mounted in said probe housing, said microprocessor connected to said sensor for processing a reflected light signal; and
a display connected to said microprocessor for displaying a color measurement as a single measurement value.

8. The device as claimed in claim 7, wherein aid display is a liquid crystal display integrally mounted in said probe housing.

9. The device as claimed in claim 7, wherein said display is an electronic device connected to said microprocessor.

10. The device as claimed in claim 7, wherein said light source is a LED light source.

11. A method for determining a color of an object using a color measuring device, said device having a probe housing with a probe tip, a light source, a sensor, a microprocessor and a display screen connected to a power source, the steps comprising:
illuminating an object with a light source;
capturing a reflected light signal off the object inside the probe housing;
measuring the reflected light signal on the sensor;
processing the sensor measurement using the microprocessor; and
displaying a single color measurement value.

12. The method as claimed in claim 11, wherein the step of displaying further includes a step of displaying a single color measurement value.

13. The method as claimed in claim 11, wherein the step of capturing a reflected light signal further includes a step of capturing said reflected light signal inside a light pipe received inside said probe housing.

14. The method as claimed in claim 11, wherein the step of displaying further includes a step of displaying a single color measurement value on an electronic device connected to said microprocessor.
